(19) United States
(12) Patent Application Publication
(10) Pub. No.: US 2010/0307671 A1
(43) Pub. Date: Dec. 9, 2010

(54) METAL ORNAMENTATION METHOD

(76) Inventor: Zoltan David, Austin, TX (US)

Correspondence Address: David Allen Hall, P.O Box 1540, Blanco, TX, 78606, US

(21) Appl. No.: 12/508,698

(22) Filed: Jul. 24, 2009

Related U.S. Application Data
(60) Provisional application No. 61/213,441, filed on Jun. 8, 2009.

(51) Int. Cl. B32B 38/10; B05D 3/00

(52) U.S. Cl. 156/247; 427/327; 427/328

(57) ABSTRACT

A method of creating jewelry and other metallic objects with hard, durable, colored surfaces decorated with relatively soft precious metal surfaces and shapes.

This application claims priority from and incorporates by reference provisional application 61/213,441 filed by the same sole inventor on Jun. 8, 2009.

### BACKGROUND OF THE INVENTION

There is a consumer market for decorative or ornamented metallic products combining precious metals and colored features. Anodization, thin films, and paints permit colorization of various metals, but lack the scratch, abrasion, and wear resistance desirable in products including, but not limited to, rings, watches, spectacle frames, buckles, knife handles, and purse clasps.

### SUMMARY OF THE INVENTION

The present invention eliminates or alleviates the above-mentioned limitation of state of the art ornamentation of metallic products. The present invention provides a method for producing high-quality jewelry and other metallic products combining precious metal ornamentation with wear resistant colored finishes.

The preferred embodiment of the present invention is a method of (1) inlaying and otherwise incorporating precious metals into a hard, wear resistant, uncolored substrate, for example, the main body or band of a bracelet or finger ring, (2) subsequently processing the bracelet or ring in such a way as to impart a colored finish to its entirety, and (3) selectively removing the colored finish from the precious metal. The result is a bracelet or ring tile main body of which has a colored finish having the hardness of the main body substrate metal, and which has precious metal ornamentation.

### BRIEF DESCRIPTION OF THE DRAWINGS

FIG. 1 shows a soft-material model of the final product ring complete with decorative carved or scribed channels and voids.

FIG. 2 shows the cast metallic substrate of the final product ring.

FIG. 3 shows the cast metallic substrate with the decorative channels and voids inlaid with precious metal and a precious metal sleeve sized for insertion into the ring.

FIG. 4 shows the cast substrate, its precious metal inlays, and its precious metal interior sleeve after the entire assembly has been highly polished.

FIG. 5 shows the entire assembly after all surfaces have undergone a physical vapor deposition (PVD) process.

FIG. 6 shows the finished product ring after the PVD finish has been removed from all precious metal surfaces in a buffing process.

### DEFINITIONS

Terminology used herein describes particular embodiments only, and is not intended to be limiting. As used in the specification, including the claims, the singular forms “a”, “an”, and “the” include singular and plural referents unless the content dictates otherwise. Unless defined otherwise, all technical and scientific terms used herein have meanings commonly understood by one of ordinary skill in the relevant art or industry.

“Cobalt-chromium” or “CoCr” herein generally refers to a steel alloy commonly used in various metal-working industries in applications requiring high resistance to wear, corrosion, and heat. A CoCr alloy may contain various amounts of metals other than cobalt and chromium.

“Jewelry” herein generally refers to objects ornamented with precious metals and/or gemstones. Such objects can be purely decorative or partially utilitarian.

“Metallic objects” herein generally refers to objects wholly or partially constructed of metals, combinations of metals, and other materials including but not limited to metallic-coated plastics, woods, and composites.

“Negative spaces” herein generally refers to holes, cavities, channels or the like that are capable of receiving fillers such as molten or solid metal or gemstones. Negative spaces are not necessarily bounded on all sides. The space circumscribed by a ring or bracelet is herein considered a negative space.

“Physical Vapor Deposition” or “PVD” herein generally refers to the creation of a metal vapor that can be reacted with different gases to form a thin, molecularly bonded coating, usually within a vacuum chamber. When used in conjunction with the PVD process, “coating” herein refers to a molecular bond rather than a conventional surface covering.

“Precious metal” herein generally refers to rare metallic substances of high value including, but not limited to, gold, silver, ruthenium, rhodium, palladium, osmium, iridium, and platinum, but can also refer to less rare substances including, but not limited to, copper, bronze, and turquoise.

### DETAILED DESCRIPTION OF THE PREFERRED EMBODIMENT

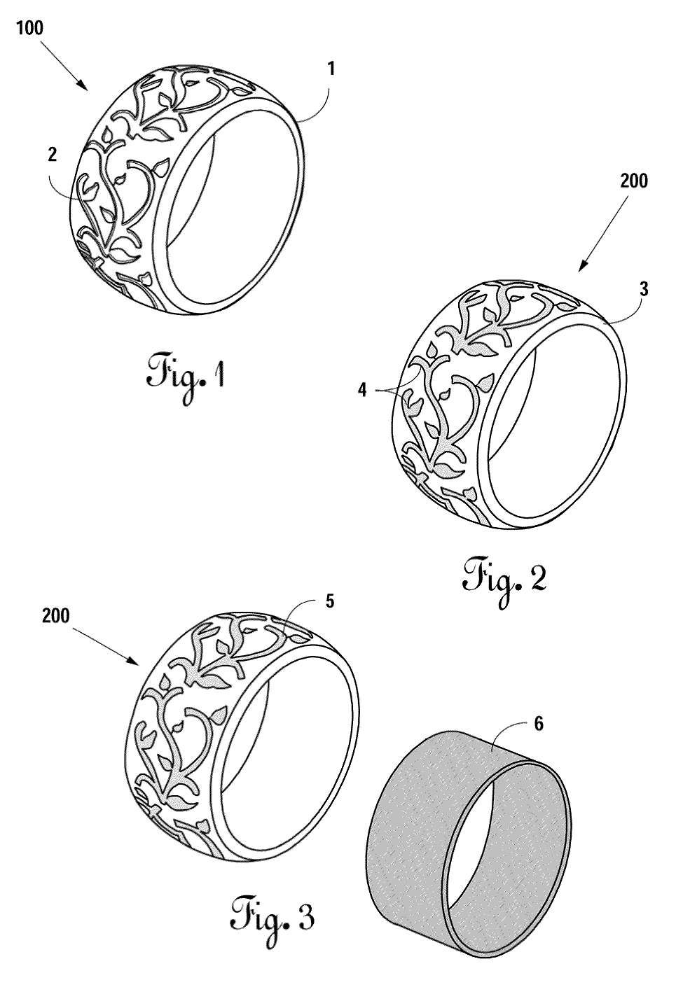

The lost wax process is the first step of the preferred embodiment of the present invention method of creating a ring ornamented with 24K gold, the CoCr main body or substrate of which has a colored finish having substantially the same hardness of the main body. FIG. 1 shows a wax or resin model 100 of the desired ring. A decorative pattern 2 of channels and voids is carved or scribed into the model's main body 1.

The lost wax process has been used for thousands of years to produce complex metal objects. The method permits anything that can be modeled in wax to be faithfully cast in metal, and is still used for hardware, dental restorations, jewelry, and sculpture.

While wax patterns originally were, and can still be modeled by hand, it is now possible to cast wax into molds so that multiple copies may be made even though the wax pattern is lost in the process. Modern synthetic rubbers can now capture fine detail and can flex to release undercut areas of a model, thus minimizing the required number of mold parts and parting lines. Wax casts can be solid or hollow, as the wax will coat the inside of a mold after it is filled and poured out. Repeated coating will build up the wax to the desired thickness.

The small dimensions typically involved in the jewelry industry necessitate lost wax process modifications in order to overcome the effects of surface tension. Such modifications might include wax injection instead of pouring, and the use of a vacuum table or centrifugal casting machine for forcing metal into molds.

After it is created, the wax or resin model is attached to a pour-cup, which is funnel-shaped to facilitate channeling of molten metal into the mold using gates or sprues made from rods of wax. A venting system is made the same way to convey air and other gasses out of the mold while it is being filled with hot metal. Once the model is complete with gates and vents, it is surrounded with a material that will cover it smoothly when wet and withstand high temperatures when baked.

A silicaceous slurry is used to cover the model. A dry aggregate is then applied to the wet pattern, either by hand or by using a fluidized bed, a confined space in which dry particles are blown and circulated until all wet areas are covered. This is repeated, using coarser aggregate on the outermost layers, until a sufficient thickness has built up so the mold will remain intact through the burn-out and pouring.

The other method commonly used is called investment casting. More venting is necessary due to the decreased porosity of the mold material, which is made using gypsum plaster (plaster of Paris) as a binder for sand, silica flour, or another refractory aggregate. There are many proprietary investment mixtures available. The dry ingredients are mixed with water and poured into a container or flask surrounding the gated model, which is either anchored to a board or attached to a commercially available rubber device that holds the pattern and flask. Jewelry flasks are generally placed in a vacuum chamber where the investment mixture is boiled at room temperature to remove air bubbles that tend to cling to the model. Decanting the investment mixture before pouring it over the wax model reduces boiling-over when vacuuming.

When the plaster mixture has hardened, the flask is placed in a kiln, slowly heated to between 1000 and 1250 degrees F., and maintained at that temperature until all wax residues have disappeared. The place where the wax was is now a void, hence the “lost wax” designation. The mold is then filled with molten metal. After the flask has cooled and the plaster mold is removed, the cast metal product, which faithfully reproduces every detail of the original wax model, plus the gates and vents, is revealed. The gates and vents must be cut off. Special investment materials and equipment are necessary to deal with the high temperatures required for casting certain materials, but the process is much the same.

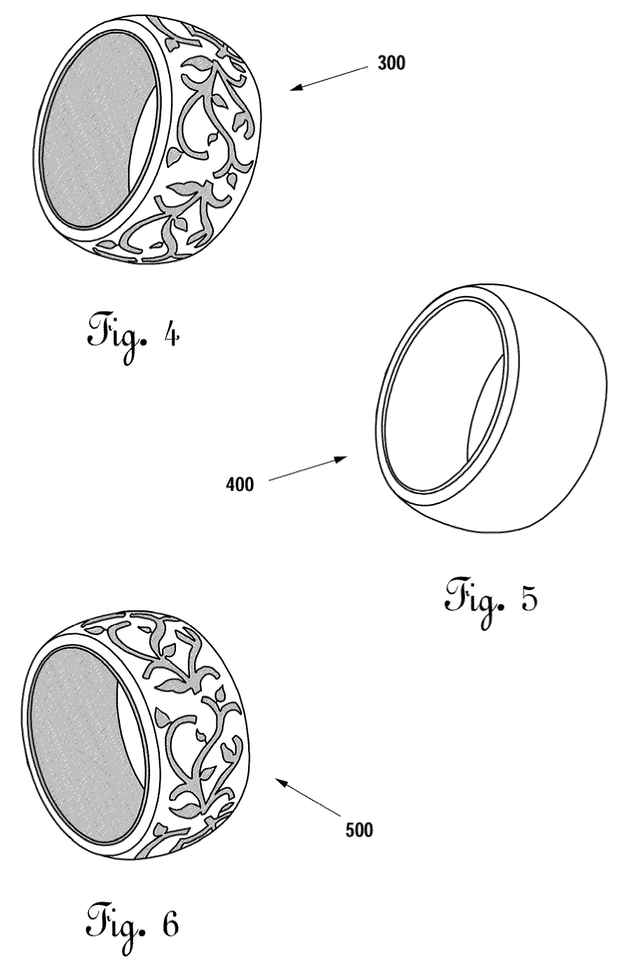

The second step of the preferred embodiment of the present invention method is inlaying 24K gold into the decorative channels and voids of the CoCr ring main body that results from the lost wax process, and fixing a 24K gold sleeve inside the same casting. FIG. 2 shows the casting 200 of the CoCr substrate 3 and its decorative pattern 4 of channels and voids. FIG. 3 shows the casting 200 inlaid with 24K gold 5 and a 24K gold sleeve 6 sized for insertion into the casting 200. Next, as shown in FIG. 4, the cast substrate, its gold inlays, and its gold sleeve are highly polished to form ring 300, which is then treated with a PVD process.

The PVD process produces architectural and telecom products, nautical hardware, knives, blades, drills, gas turbine parts, appliances, automotive parts, firearms, and other products requiring a high degree of scratch, wear, and abrasion resistance. Substrate materials range from steel to pre-plated plastic. PVD coatings can be deposited as mono-layers, multi-layers, and graded layers. The coating structures can be modified in terms of such properties as crystallographic orientation and nano-composite structure in order to produce the desired hardness, elasticity, adhesion, and color. The final coating choice is determined by the demands of the application. Coating thicknesses can range from 2 microns to 15 or more microns. The PVD process for the preferred embodiment of the present invention was provided by the Greensboro, N.C. a plant of IonBond, a provider of coating technology expertise in 39 locations in the United States, Mexico, Europe, and Asia.

FIG. 5 shows the result of application of the PVD process to ring 300. All surfaces of ring 400 are at this point unifomily colored the predetermined color imparted by the PVD process, but the surface hardness is not uniform. Because of the surface molecular bonding characteristic of PVD, the colored PVD coating on all CoCr surfaces has acquired the hardness of the CoCr, approximately 400 Vickers hardness, whereas the same-colored PVD coating on all 24K gold surfaces has acquired the hardness of the softer gold, approximately 100 Vickers hardness.

Finally, FIG. 6 shows the finished product ring 500 after the PVD finish has been removed from all 24K gold surfaces in a buffing process using a lathe or other rotary devices and various polishing compounds such as Menzerna (a tripol compound) in a regimen starting with a coarse aggressive polishing compound and finishing with a polishing rouge. The hard ring substrate is colored the color imparted by the PVD process, but the exposed ornamentation and sleeve surfaces retain the luster of 24K gold.

An alternate embodiment of the present invention includes delay of the ornamentation steps until after the PVD process has been completed. 24K gold can be inlaid and a 24K gold sleeve can be press fit into the casting subsequent to its PVD treatment. In either embodiment the ornamentation can then be modified with polishing or shaping with methods such as those described by David in U.S. Pat. No. 6,594,901. The ornamentation can also include the setting of gemstones in the substrate or inlays.

It will be apparent to those with ordinary skill in the relevant art having the benefit of this disclosure that the present invention provides methods for creating jewelry and other metallic objects with hard, durable, colored surfaces decorated with relatively soft metallic surfaces and shapes, and/or gemstones. It is understood that the forms of the invention shown and described in the detailed description and the drawings are to be taken merely as the currently preferred embodiments, and that the invention is limited only by the language of the claims. The drawings and detailed description presented herein are not intended to limit the invention to the particular embodiments disclosed.

While the present invention has been described in terms of two preferred embodiments, it will be apparent to those skilled in the art that form and detail modifications can be made to the described embodiments without departing from the spirit or scope of the invention. For example, application of the present invention method is not limited to jewelry, and ornamentation is not limited to gold. Also, substrates are not limited to CoCr; other materials including but not limited to titanium and zirconium may be used.

With benefit of this disclosure and accompanying drawings, all methods described herein can be preformed without undue experimentation.

I claim:

1. A method of creating an ornamented cobalt chromium alloy object comprising:
(a) creating a negative space in said object; and
(b) at least partially filling said space with an ornamental substance.

2. The method as in claim 1 wherein said object is an article of jewelry.

3. The method as in claim 1 wherein said ornamental substance is a precious metal.

4. The method as in claim 1 wherein said ornamental substance is a gemstone.

5. A method of creating an ornamented metallic object comprising:
(a) creating a negative space in said object;
(b) at least partially filling said space with an ornamental substance;
(c) treating said object and said ornamental substance with a physical vapor deposition coating; and
(d) removing said coating from said ornamental substance.

6. The method as in claim 5 wherein said object is an article of jewelry.

7. The method as in claim 5 wherein said ornamental substance is a precious metal.

8. A method of creating an ornamented metallic object comprising:
(a) creating a negative space in said object;
(b) treating said object with a physical vapor deposition coating; and
(c) at least partially filling said space with an ornamental substance.

9. The method as in claim 8 wherein said object is an article of jewelry.

10. The method as in claim 8 wherein said ornamental substance is a precious metal.

11. The method as in claim 8 wherein said ornamental substance is a gemstone.
